(19) United States
(12) Patent Application Publication
(10) Pub. No.: US 2025/0029793 A1
(43) Pub. Date: Jan. 23, 2025

(54) OF ANODE LEAD ATTACHMENT FOR SOLID CATHODE ELECTROLYTIC CAPACITOR

(71) Applicant: KEMET Electronics Corporation, Fort Lauderdale, FL (US)

(72) Inventors: Brandon Summey, Simpsonville, SC (US); Jeff Poltorak, Simpsonville, SC (US); Robert Ramsbottom, Simpsonville, SC (US); Kevin Agosto, Simpsonville, SC (US)

(21) Appl. No.: 18/775,792

(22) Filed: Jul. 17, 2024

Related U.S. Application Data
(60) Provisional application No. 63/527,692, filed on Jul. 19, 2023.

(51) Int. Cl. H01G 9/042; H01G 9/012; H01G 9/15

(52) U.S. Cl. CPC H01G 9/0425; H01G 9/012; H01G 9/08; H01G 9/15

(57) ABSTRACT

A solid cathode electrolytic capacitor and method of making a solid electrolytic capacitor are provided. The capacitor comprises an anode comprising an anode lead and an anode lead extension extending from the anode lead. The anode lead and anode lead extension are joined at a weld region. A dielectric is on the anode and a cathode is on the dielectric.

### CROSS-REFERENCE TO RELATED APPLICATIONS

This application claims priority to pending U.S. Provisional Application No. 63/527,692 filed Jul. 19, 2023 which is incorporated herein by reference.

### BACKGROUND OF THE INVENTION

The present invention is related to improvements in electrical connectivity for capacitors. More specifically, the present invention is directed to improved connectivity between the anode and external termination in a capacitor.

There is a continuing effort to improve electrical devices. The skilled artisan is constantly seeking to achieve improvements in functionality, size and cost of electrical devices and this desire is correlated to the increased demand for electrical vehicles, portable electronics and the like. A critical part of improving electrical devices is focused on improving the electrical components of the electrical device. More specifically, a critical part of improving electrical devices, and electrical components, is improving the electrical connectivity of the electrical component to the circuitry in the electrical device.

The present application is specific to solid cathode electrolytic capacitors, as a representative electrical component, and more specifically, improved connectivity of a solid cathode electrolytic capacitors to a circuit to form an electrical device. The connectivity between the anode of a solid cathode electrolytic capacitor typically includes an anode lead wherein the anode lead extends to an anode lead frame which functions as the external termination. The electrical connectivity associated with the anode lead and anode lead frame consumes a significant volume thereby limiting further improvement, and particularly miniaturization, of electrical components and electrical devices comprising the electrical components.

There are a number of design and manufacturing improvements for creating electrical connections that provide a more robust and/or more efficient method of manufacturing. Many of these improvements are related to the method in which the anode lead is connected to the anode lead frame.

The anode lead typically comprises tantalum, though other metals can also be used, wherein the tantalum anode lead is resistance welded to the anode lead frame to provide electrical and physical connection of the electrical component to a circuit trace. The tantalum anode lead is welded to the anode lead frame. The process requires physical separation between the weld point and capacitor body wherein the physical separation occupies a significant portion of the final device volume.

There are a number of process improvements in the industry focused on reducing the amount of space required for the connection point of the anode lead to the anode lead frame. Some of those improvements include changes to the anode lead frame designs; attaching a portion of material, referred to as an anode node, to the anode lead frame and between the anode lead and anode lead frame; and replacing the anode lead frame with metallization or plating on the surface. Each of those options comes with advantages and limitations. The anode lead frame changes can come with added cost and complexity as well as limits to how much space reduction can be achieved. Welding a portion of material to the anode lead before attaching to the anode lead frame can further reduce the space required but requires the attachment method to be close enough to the capacitor body as to make it difficult to avoid damaging the fragile capacitor body. Resistance welding a portion of material prior to forming dielectric or cathode layers creates a risk of electrical shorting through the new portion of material which can inhibit formation of the dielectric and cathode. The methods of attaching these portions can also be costly and difficult to achieve the desired results at manufacturing scale.

When forming an anode node the materials are limited and typically selected based on their ability to form a metallization layer. The method of attachment to the anode lead is also limited. Resistance welding must not be close to the anode surface since the process can damage the capacitor element. Other problems include localized heat from welding methods which are in close proximity to the capacitor body. Material splatter from the welding operation is also a concern. With laser welding problems can be created by reflected radiation from the laser.

Metalized terminals have become a popular method for reducing the space requirements for the connection point between the anode lead and anode lead frame. Most designs that use metalized terminals still require the attachment of a portion of material between the anode lead and the anode lead frame to improve the electrical or physical connection. This is due to the tantalum metal forming a strong oxide which limits bonding to most metals. The limitations of that anode node still exist when it is implemented with metalized terminals.

In spite of the efforts those of skill in the art still seek improvements in the method for attaching an anode lead to an anode lead frame. Provided herein is an improved electronic component, specifically a solid cathode electrolytic capacitor, comprising an improved termination of the anode lead to an anode lead frame.

### SUMMARY OF THE INVENTION

It is an object of the invention to provide an improved solid cathode electrolytic capacitor comprising improve connectivity between the anode and external termination.

It is another object of the invention to provide an improved solid cathode electrolytic capacitor with a reduced volume, particularly, in the region of the anode lead and connectivity of the anode lead to the external termination.

A particular feature of the invention is the ability to form an improved solid cathode electrolytic capacitor without the necessity of a lead frame which further improves the volumetric efficiency, or capacitance as a function of capacitor volume.

These and other advantages, as will be realized, are provided in a solid cathode electrolytic capacitor. The capacitor comprises an anode comprising an anode lead and an anode lead extension extending from the anode lead. The anode lead and said anode lead extension are joined at a weld region wherein the anode lead extension is a valve metal. A dielectric is on the anode and a cathode is on the dielectric. An encapsulation encapsulates the anode wherein one of the weld region or anode lead extension extends to a surface of the encapsulation. A metallization is on the encapsulation wherein the metallization is in electrical contact with the weld region or anode lead extension.

Yet another embodiment is provided in a method of forming a solid cathode electrolytic capacitor comprising:
forming an anode comprising an anode lead;
attaching an anode lead extension to the anode lead wherein the anode lead and the anode lead extension are joined at a weld region and wherein the anode lead extension is a valve metal;
forming a dielectric on the anode; and
forming a cathode on the dielectric.

Yet another embodiment is provided in a solid cathode electrolytic capacitor comprising an anode and an anode lead extending to a surface of the anode. An anode lead extension extends from the anode lead wherein the anode lead extension is joined at a weld region to the anode lead wherein the anode lead extension is a valve metal. A dielectric is on the anode. An encapsulation encapsulates the anode wherein one of the weld region or the anode lead extension extends to a surface of the encapsulation. A metallization is on said encapsulation wherein the metallization is in electrical contact with the weld region or anode lead extension.

### BRIEF DESCRIPTION OF DRAWINGS

FIG. 1 is a schematic perspective view illustrating an embodiment of the invention.

FIG. 2 is schematic cross-sectional view showing an embodiment of the invention.

FIG. 3 is a flow chart representation of an embodiment of the invention.

### DETAILED DESCRIPTION OF THE INVENTION

The present invention is related to improved connectivity of the anode lead to the anode external termination without the necessity of a lead frame. More specifically, the present invention is related to a solid cathode electrolytic capacitor comprising a metallization layer in direct electrical contact with the anode lead, preferably through the weld region and anode lead extension, wherein the metallization layer functions as the anode external termination.

A particular feature of the instant invention is the attachment of the anode lead to an anode lead extension prior to the formation of the dielectric on the anode. By forming the anode lead extension earlier in the process of manufacturing the anode lead extension can be formed before the capacitor becomes fragile, such as after the dielectric is formed. This avoids the challenges associated with electrical shorting through the anode and anode lead.

In the present invention an anode lead extension is attached to the anode lead prior to forming a dielectric wherein the anode lead extension comprising material that is compatible with anodization of the anode, to form the dielectric, and formation of cathode layers on the dielectric. The capacitor element is terminated by the formation of metallization layers which are in electrical contact with the anode lead extension and/or an weld region.

Particularly preferred metals for the anode lead extension include titanium, tungsten, nickel, or a valve metal with preferred valve metals selected from the group consisting of selected from the group consisting of tantalum, aluminum, niobium, titanium, zirconium, hafnium, and NbO. An anode lead extension comprising aluminum is preferred. In an embodiment the anode lead extension is a different material than the anode or the anode lead. A particular advantage of the invention is the ability to use different materials for the anode lead and anode lead extension with a tantalum anode lead and aluminum anode lead extension being particularly suitable for demonstration of the invention.

The high melting temperature of tantalum in the anode lead complicates attachment of an anode node or other metal material and it has therefore been avoided in the past. The heat required to melt tantalum is sufficient to cause aluminum, for example, to evaporate and therefore it is difficult to form an adequate bond between the aluminum and tantalum.

Aluminum is desirable to use because there are a number of established plating methods as well as other metallization techniques, such as but not limited to, sputtering, flame spray and chemical/physical/vapor deposition suitable for use with aluminum. Creating the attachment to the anode lead using a much lower melting point material is a challenge, and more so to attach it effectively in close proximity to the delicate capacitor.

In the present invention the anode lead extension is attached to the anode lead, preferably in colinear relationship, by arc welding. Arc welding is a process that utilizes an arc of electrical energy between two non-contacting surfaces prior to making contact between the surfaces. This process forms a high voltage potential between two materials, the anode lead and anode lead extension in this example, with enough potential to form ionization between the materials. By moving the two materials close together in the presence of a high voltage potential an arc forms in the air gap between the materials. The heat from this arc is mostly contained in the air gap and at the surfaces between the materials. Due to its rapid formation limited amounts of the heat are conducted through the materials below the surface. In such settings far less energy is required to achieve two liquid metal surfaces. When those two surfaces are brought together they intermix and form a weld joint before solidifying. This provides mechanical mixing as well as potential intermetallic formation.

The invention will be described with reference to the figures which are an integral, but non-limiting, part of the specification provided for clarity of the invention. Throughout the various figures similar elements will be numbered according.

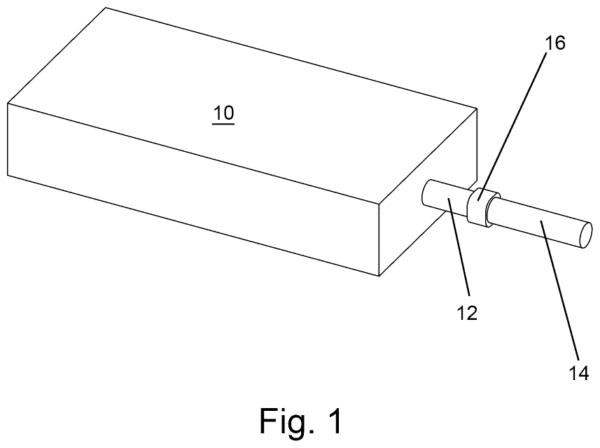

An embodiment of the invention will be described with reference to FIG. 1 wherein an anode is illustrated in schematic perspective view. In FIG. 1 the anode, 10, is represented as a monolith which is formed of pressed and sintered powder. An anode lead, preferably comprising tantalum extends from the anode. The anode lead, 12, is preferably embedded in the anode and inserted into the powder prior to pressing the powder to form the anode. The anode lead may be flush with the face of the anode or it may protrude from the anode body. It is particularly preferred that the anode lead protrude to, at least, the surface of the anode to no more than 0.25 mm from the anode surface. Beyond 0.25 mm the volumetric efficiency diminishes and therefore the advantages of the invention are not realized. A flush anode lead, wherein the anode lead breaches the surface of the anode but does not extend beyond the face of the anode, is advantageous since the arc welding can be accomplished without generating heat in the anode body. In an embodiment the face of the anode is the flush anode lead which allows for the arc welding of an anode lead extension directly to the surface of an anode body. An anode lead extension, 14, extends preferably collinearly from the anode lead. A weld region, 16, at the junction of the anode lead and anode lead extension is preferably formed by arc welding and it would be understood that the weld region would be separated from the anode by about the same distance as the end of the anode lead or no more than about 0.25 mm. In one embodiment the anode extension is a valve metal welded directly to the surface of the monolith, 10.

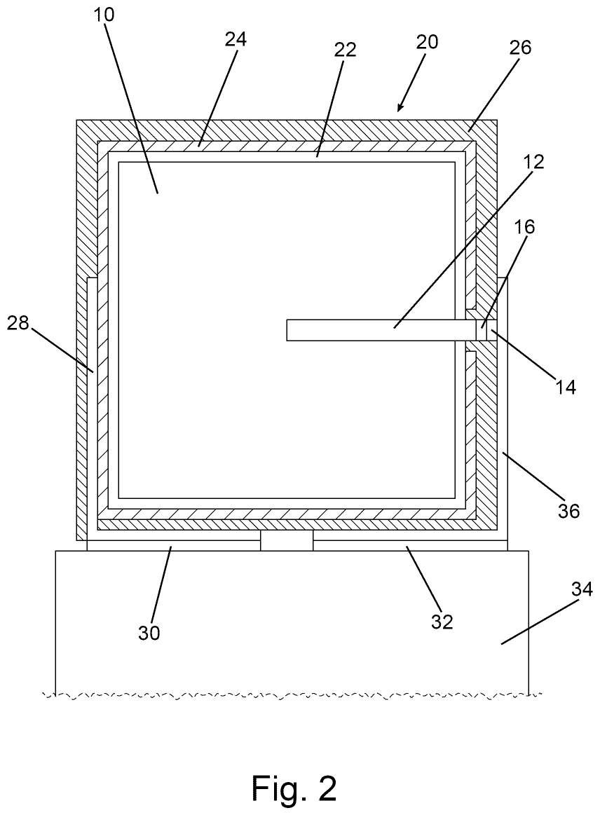

An embodiment of the invention will be described with reference to FIG. 2. In FIG. 2 a capacitor, 20, is illustrated in schematic cross-sectional view. The anode has an anode lead, 12, extending therefrom. An anode lead extension, 14, which is preferably colinear with the anode lead is attached to the anode lead at a weld region, 16. A dielectric, 22, preferably encases the entire anode and optionally the anode lead, weld region and anode lead extension. A cathode, 24, encases a portion of the dielectric with the understanding that the cathode is not in electrical contact with the anode, anode lead, weld region or anode lead extension. A cathode termination, 28, is in electrical contact with the cathode and provides electrical connectivity to a cathode trace, 30, when mounted to an electrical circuit of an electrical device, 34. In this example this cathode termination is shown as a traditional leadframe for reference only. An encapsulant, 26, encases the entirety of the capacitor, with the exception of a portion of the cathode lead necessary for mounting. A metallization layer, 36, is on the surface of the encapsulant and in electrical contact with the weld region or anode lead extension terminating at the surface of the encapsulant. A metallization layer is formed on the surface of the encapsulant wherein the metallization is in electrical contact with the weld region or anode lead extension. The metallization forms an electrical contact with and anode trace, 32, when mounted to an electrical circuit of the electrical device, 34.

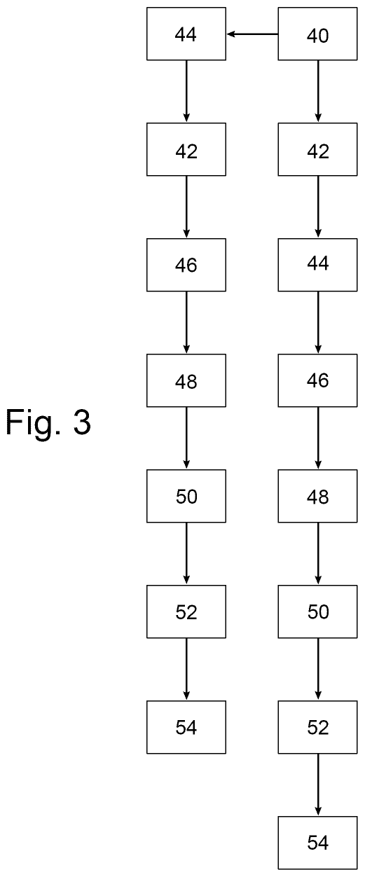

An embodiment of the invention is illustrated in flow chart representation in FIG. 3. An anode is formed at 40 wherein the anode comprises an anode lead extending to or beyond a boundary of the anode. The anode is preferable formed by compressing a powder, preferably with a wire embedded therein, wherein the wire forms the anode lead. An anode lead extension is attached, preferably co-linearly to the anode lead, at 42. In a particularly preferred embodiment, the anode lead extension is attached to the anode lead by arc welding. The anode is sintered at 44. Sintering adheres the anode to the anode lead as known in the art. The sintering can occur prior to anode lead extension attachment or after attachment of the anode lead extension to the anode lead resulting in a sintered anode with an anode lead and anode lead extension extending therefrom. The anode lead and anode extension are preferably wires, wherein a wire is functionally round in cross-section, for manufacturing convenience without limit thereto. The anode or anode extension can be other than a wire such as a foil or web material.

With further reference to FIG. 3, a dielectric is formed on, at least, the sintered anode at 46. Dielectric formation is well known in the art and not limited herein. The dielectric may extend to the anode lead, the welding region or a portion of the anode lead extension. A cathode is then formed on the dielectric at 48 wherein the cathode comprises a conductive layer and preferably adhesion layers which facilitate attachment of a cathode lead frame to the cathode. The adhesion layers preferably comprise a carbon layer directly on the cathode and a metal layer on the carbon layer.

While not limited herein, it is preferable to attach a cathode lead to the cathode at 50 wherein the cathode lead allows electrical conductivity when the capacitor is electrically mounted to an electrical device. External connectivity for the cathode can also be achieved using exposed leads through the encapsulant and metallization to create the connection between the terminal and internal cathode component.

The capacitor is encapsulated at 52. It is preferable to encase the entire capacitor except for the terminal end of the cathode lead and the terminal end of the anode lead extension or welding region.

With continued reference to FIG. 3 a metallized layer is formed on the surface of the encapsulant at 54 wherein the metallized layer is in electrical contact with the anode lead extension or welding region. To maximize volumetric efficiency a similar method can be used to form the electrical contact for the cathode layers.

The anode is a conductor. A preferred anode is a metal and preferably a valve metal selected from the group consisting of tantalum, aluminum, niobium, titanium, zirconium, hafnium, alloys of these elements, and a conductive oxide thereof such as NbO. The anode lead is preferably tantalum without limit thereto. In an embodiment which is particularly suitable for demonstration of the invention the anode lead comprise the same metal as the anode. There are two preferable forms of the anode lead. In one form the anode lead is a valve metal wire, typically pressed into the anode body and made of the same valve metal. This anode lead is sintered with the anode body to form a bond between the anode lead and anode body. In another form the anode lead may be a region of the anode body. In this case the anode lead extension, typically a wire, but not limited too, is attached to the anode body directly in the region described as the anode lead. A portion of the anode body may also contain a solid region of the valve metal along with a region where the surface area has been increased. In that configuration the solid region would be the preferred connection point for the anode lead extension.

The dielectric is preferably a continuous dielectric layer on the anode and preferably covers at least the entire surface of the anode. The dielectric layer may extend onto the anode lead and may extend onto the weld region and onto the anode lead extension. In an embodiment the dielectric layer extends onto the anode lead extension as a continuous coating. In an embodiment the dielectric extends to the anode lead extension but does not encompass the anode lead extension. It is preferred that the anode lead extension is a valve metal so that the dielectric will form a continuous insulating layer in a region of the anode, including anode lead, weld region, and anode lead extension. In the preferred, the difficulties of preventing electrical contact of the cathode and any portion of the anodes are reduced due to the anode lead extension being capable of a similar dielectric formation.

The dielectric is not particularly limited herein, however there is a preference in the art for a dielectric which is an oxide of the anode for manufacturing conveniences. The formation of a dielectric layer on an anode is well known in the art and not particularly limited herein and further description of the method of dielectric formation is not warranted. When a valve metal is used as the anode lead extension the dielectric formed from the anode lead extension may provide further protection from cathode layers and prevent electrical shorting.

A cathode is on the dielectric and preferably covers a majority of the dielectric. The cathode layers are not limited herein and are consistent with those commonly found in the capacitor industry including cathode layers comprising conductive polymer, or manganese dioxide, on the dielectric. One of skill in the art would understand that the cathode and anode are separated by the dielectric wherein the anode and cathode form the capacitive couple. While not limited herein the cathode preferably comprises a conductive polymer, such as a polythiophene, or a conductive metal layer such as manganese dioxide. Adhesion layers are typically utilized as part of the cathode to improved adhesion to the cathode termination.

The conductive polymer layer can be formed by many methods known in the art such as, in situ polymerization, one pot polymerization, electrochemical polymerization, or prepolymerized polymer dips. Particularly preferred conductive polymers are polyanilines, polypyrroles, polythiophenes and derivatives thereof. A preferred polymer for demonstration of the invention is poly-3,4-ethylenedioxythiophene or derivatives thereof. Additional cathode layers are preferably formed on the conductive polymer layer or manganese dioxide layer to facilitate connecting of the cathode external termination thereto with carbon containing layers and metal containing layers being particularly suitable for demonstration of the invention. The metal containing layers may be in the form of a conductive ink, deposited metal layer, or plating layer or any combination thereof.

Metallization on a surface is well known in the art and not particularly limited herein. Metallization is typically accomplished by a method selected from plating, sputtering, deposition, sintering, diffusion, coating, and applying a conductive material, preferably a metal. The metallization may be a single metal, an alloy, or a sequential series of metals to achieve adequate electrical conductivity. The metal used for metallization is not particularly limited with the proviso that the metallization is solderable and forms an electrical connection, and preferably a metallurgical bond, to the anode lead extension.

Arc welding allows the anode lead extension to be welded to the anode lead prior to formation of the dielectric or cathode layers of the anode. This allows for the high voltage weld fixture to be in connection with the entire anode, not just the limited exposed portion of a finished capacitor element.

### Example 1

Tantalum powder was pressed around a tantalum anode lead forming an anode body and anode lead wherein the anode lead protruded form the anode body. It is preferable that the anode lead may protrude between 0.0 mm and 0.25 mm. The anode was sintered to form a bond between the powder and the anode lead. A percussion arc weld was used to attach an aluminum wire, as an anode lead extension, collinearly to the anode lead, where the two ends of each anode lead and aluminum wire were connected, forming a continuous length of lead that was in the same direction as the original protrusion of anode lead or approximately perpendicular to the anode surface. The anode, a portion of the anode lead, the weld region and a portion of the aluminum wire, were anodized using conventional techniques to form a dielectric layer covering the surface of the anode, the anode lead, the weld region and a portion of the anode lead extension. The dielectric layer was then coated with conductive polymer, carbon ink, and silver paint to form a finished capacitor element. Excess cathode material was cleaned from the anode lead where the weld region between the tantalum and aluminum was formed. This finished capacitor element was encapsulated in such a way that the weld joint between the tantalum and aluminum wire was exposed so that a portion of the aluminum wire was exposed at the surface of the encapsulant. A metallization, preferably plating, was formed on the encapsulant and electrically connected to the aluminum portion of the exposed anode lead. This metallization formed the terminal of a finished encapsulated device.

The advantage of this example is the bond formed between the Ta and Al occurs closer to the anode than a typical node application. The typical node process would require a weld overlap portion between the anode lead and anode node and would typically have a portion of node material that protrudes in a direction towards the anode. If that material set is not compatible or formed post dielectric/cathode, then that protrusion towards the anode may interfere with the capacitor performance. In the example the aluminum portion is attached to the anode lead before the dielectric/cathode layers are formed and forms a stable dielectric. That protruding portion of aluminum with a formed dielectric on its surface does not interfere with the performance of the capacitor and can be moved closer to the anode top surface, providing more volumetric efficiency.

U.S. Pat. No. 8,451,586 is incorporated herein by reference.

The invention has been described with reference to preferred embodiments without limit thereto. One of skill in the art would realize additional embodiments which are described and set forth in the claims appended hereto.

1. A solid cathode electrolytic capacitor comprising:
an anode comprising an anode lead;
an anode lead extension extending from said anode lead wherein said anode lead and said anode lead extension are joined at a weld region wherein said anode lead extension is a valve metal;
a dielectric on said anode;
a cathode on said dielectric;
an encapsulation encapsulating said anode wherein one of said weld region or said anode lead extension extends to a surface of said encapsulation; and
a metallization on said encapsulation wherein said metallization is in electrical contact with said weld region or said anode lead extension.

2. The solid cathode electrolytic capacitor of claim 1 wherein said anode lead and said anode lead extension comprise different metals.

3. The solid cathode electrolytic capacitor of claim 1 wherein said weld region is no more than 0.25 mm from said anode.

4. The solid cathode electrolytic capacitor of claim 1 wherein said anode lead is a wire.

5. The solid cathode electrolytic capacitor of claim 1 wherein said anode lead is a region of said anode.

6. The solid cathode electrolytic capacitor of claim 1 wherein said anode extension comprises a valve metal selected from the group consisting of tantalum, aluminum, niobium, titanium, zirconium, hafnium, and NbO.

7. The solid cathode electrolytic capacitor of claim 1 wherein said anode lead extension and said anode lead are colinear.

8. The solid cathode electrolytic capacitor of claim 1 wherein said dielectric encases a portion of said anode lead.

9. The solid cathode electrolytic capacitor of claim 8 wherein said dielectric encases a portion of said weld region.

10. The solid cathode electrolytic capacitor of claim 9 wherein said dielectric is continuous and further encases a portion of said anode lead extension.

11. The solid cathode electrolytic capacitor of claim 1 wherein said anode comprises a valve metal.

12. The solid cathode electrolytic capacitor of claim 11 wherein said anode comprises a material selected from the group consisting of tantalum, aluminum, niobium, titanium, zirconium, hafnium, and NbO.

13. The solid cathode electrolytic capacitor of claim 11 wherein said anode extension comprises a valve metal selected from the group consisting of selected from the group consisting of tantalum, aluminum, niobium, titanium, zirconium, hafnium, and NbO and wherein said anode extension comprises a valve metal which is different than said valve metal of said anode.

14. The solid cathode electrolytic capacitor of claim 1 wherein said anode lead comprises a material selected from the group consisting of tantalum, aluminum, niobium, titanium, zirconium, hafnium, and NbO.

15. The solid cathode electrolytic capacitor of claim 14 wherein said anode lead extension comprises a metal selected from the group consisting of titanium, niobium, tungsten, nickel and aluminum.

16. The solid cathode electrolytic capacitor of claim 15 wherein said anode lead comprises tantalum and said anode lead extension comprises aluminum.

17. A method of forming a solid cathode electrolytic capacitor comprising:
forming an anode comprising an anode lead;
attaching an anode lead extension to said anode lead wherein said anode lead and said anode lead extension are joined at a weld region and wherein said anode lead extension is a valve metal;
forming a dielectric on said anode; and
forming a cathode on said dielectric.

18. The method of forming a solid cathode electrolytic capacitor of claim 17 wherein said attaching comprises arc welding.

19. The method of forming a solid cathode electrolytic capacitor of claim 17 wherein said anode lead and said anode lead extension comprise different metals.

20. The method of forming a solid cathode electrolytic capacitor of claim 17 wherein said weld region is no more than 0.25 mm from said anode.

21. The method of forming a solid cathode electrolytic capacitor of claim 17 wherein said anode extension comprises a valve metal selected from the group consisting of tantalum, aluminum, niobium, titanium, zirconium, hafnium, and NbO.

22. The method of forming a solid cathode electrolytic capacitor of claim 17 wherein said anode lead is a wire.

23. The method of forming a solid cathode electrolytic capacitor of claim 17 wherein said anode lead is a region of said anode.

24. The method of forming a solid cathode electrolytic capacitor of claim 17 wherein said anode lead extension and said anode lead are colinear.

25. The method of forming a solid cathode electrolytic capacitor of claim 17 further comprising sintering said anode.

26. The method of forming a solid cathode electrolytic capacitor of claim 25 wherein said sintering is after said attaching of said anode lead extension.

27. The method of forming a solid cathode electrolytic capacitor of claim 17 wherein said dielectric encases at least a portion of said anode lead.

28. The method of forming a solid cathode electrolytic capacitor of claim 27 wherein said dielectric encases at least a portion of said weld region.

29. The method of forming a solid cathode electrolytic capacitor of claim 28 wherein said dielectric is continuous and encases a portion of said anode lead extension.

30. The method of forming a solid cathode electrolytic capacitor of claim 17 further comprising an encapsulation encapsulating said anode wherein one of said weld region or said anode lead extension extends to a surface of said encapsulation.

31. The method of forming a solid cathode electrolytic capacitor of claim 30 further comprising forming a metallization layer on said encapsulation wherein said metallization layer is in electrical contact with said weld region or said anode lead extension.

32. The method of forming a solid cathode electrolytic capacitor of claim 17 wherein said anode comprises a valve metal.

33. The method of forming a solid cathode electrolytic capacitor of claim 32 wherein said anode comprises a material selected from the group consisting of tantalum, aluminum, niobium, titanium, zirconium, hafnium, and NbO.

34. The method of forming a solid cathode electrolytic capacitor of claim 17 wherein said anode lead comprises a material selected from the group consisting of tantalum, aluminum, niobium, titanium, zirconium, hafnium, and NbO.

35. The method of forming a solid cathode electrolytic capacitor of claim 34 wherein said anode lead extension comprises a metal selected from the group consisting of titanium, niobium, tungsten, nickel and aluminum.

36. The method of forming a solid cathode electrolytic capacitor of claim 35 wherein said anode lead and said anode lead extension comprise different metals.

37. The method of forming a solid cathode electrolytic capacitor of claim 35 wherein said anode lead comprises tantalum and said anode lead extension comprises aluminum.

38. A solid cathode electrolytic capacitor comprising:
an anode;
an anode lead extending to a surface of said anode;
an anode lead extension extending from said anode lead wherein anode lead extension is joined at a weld region to said anode lead wherein said anode lead extension is a valve metal;
a dielectric on said anode;
an encapsulation encapsulating said anode wherein one of said weld region or said anode lead extension extends to a surface of said encapsulation; and
a metallization on said encapsulation wherein said metallization is in electrical contact with said weld region or said anode lead extension.

39. The solid cathode electrolytic capacitor of claim 38 wherein said anode lead and said anode lead extension comprise different metals.

40. The solid cathode electrolytic capacitor of claim 38 wherein said anode lead is a wire.

41. The solid cathode electrolytic capacitor of claim 38 wherein said anode lead is a region of said anode.

42. The solid cathode electrolytic capacitor of claim 38 wherein said anode extension comprises a valve metal selected from the group consisting of tantalum, aluminum, niobium, titanium, zirconium, hafnium, and NbO.

43. The solid cathode electrolytic capacitor of claim 38 wherein said dielectric further extends onto said anode lead extension.

44. The solid cathode electrolytic capacitor of claim 38 further comprising an encapsulation encapsulating said anode and at least a portion of said anode lead extension wherein said anode lead extension extends to a surface of said encapsulation.

45. The solid cathode electrolytic capacitor of claim 44 further comprising a metallization on said encapsulation wherein said metallization is in electrical contact with said anode lead extension.

46. The solid cathode electrolytic capacitor of claim 38 wherein said anode comprises a valve metal.

47. The solid cathode electrolytic capacitor of claim 46 wherein said anode comprises a material selected from the group consisting of tantalum, aluminum, niobium, titanium, zirconium, hafnium, and NbO.

48. The solid cathode electrolytic capacitor of claim 46 wherein said anode extension comprises a valve metal selected from the group consisting of tantalum, aluminum, niobium, titanium, zirconium, hafnium, and NbO and wherein said anode extension comprises a valve metal which is different than said valve metal of said anode.

49. The solid cathode electrolytic capacitor of claim 38 wherein said anode lead comprises a material selected from the group consisting of tantalum, aluminum, niobium, titanium, zirconium, hafnium, and NbO.

50. The solid cathode electrolytic capacitor of claim 49 wherein said anode lead extension comprises a metal selected from the group consisting of titanium, niobium, tungsten, nickel and aluminum.

51. The solid cathode electrolytic capacitor of claim 50 wherein said anode lead comprises tantalum and said anode lead extension comprises aluminum.
